(19) United States
(12) Patent Application Publication
(10) Pub. No.: US 2018/0201424 A1
(43) Pub. Date: Jul. 19, 2018

(54) METHOD FOR THE SELECTION OF A SHAVING PRODUCT

(71) Applicant: The Gillette Company LLC, Boston, MA (US)

(72) Inventors: Sushant Trivedi, Boston, MA (US); Jacqueline Amos Gagas, Chestnut Hill, MA (US)

(21) Appl. No.: 15/922,120

(22) Filed: Mar. 15, 2018

Related U.S. Application Data
(62) Division of application No. 15/232,041, filed on Aug. 9, 2016.
(60) Provisional application No. 62/251,186, filed on Nov. 5, 2015.

(51) Int. Cl. B65D 75/52; A45D 27/00; B26B 21/22; B26B 21/44

(52) U.S. Cl. CPC B65D 75/522; A45D 27/00; B26B 21/446; B26B 21/222

(57) ABSTRACT

A method of selecting from a system of shaving products. The method includes providing information only on a first razor handle connectable in use with a razor blade cartridge. The first razor handle is configured to provide a first operative effect. The method includes providing information only on a second razor handle connectable in use with the razor blade cartridge. The second razor handle is configured to provide a second operative effect, different from the first operative effect. The method includes selecting one of the first razor handle or the second razor handle.

### FIELD OF THE INVENTION

The present invention relates to a method for the selection of a shaving product.

### BACKGROUND OF THE INVENTION

Single use disposable blister packages have the advantage of offering a very attractive solution to display a package allowing the consumer to view the product within the package. Single use disposable blister packages have been used to enclose a razor handle and cartridge(s). Razor handles and cartridges are sold as kits and packaged together within disposable blister packages. Such kits have the advantage of providing the consumer with a ready to shave option upon opening the disposable blister package containing both a razor handle and razor cartridge. However, such kits limit the user's options where razor handles having different operative effects can be connectable in use with cartridges.

Information on razor handles has typically been provided along with information on the attached razor cartridge. Such a practice is very suitable for a single razor handle that fits only one cartridge. However, where multiple razor handles having different operative effects all connect with one or more razor cartridges such a practice is less than ideal. For example, a user who is currently using a razor handle providing a pivoting feature may like to try a razor handle offering a cooling benefit. It would be desirable if the user could just purchase the cooling razor handle and connect it with existing cartridges the user has previously purchased.

In another example, a system of razor handles offering different operative effects and two or more razor cartridges that connect to each razor handle may be provided. It is desirable to allow the user to first select a razor handle providing the desired operative effect from the information provided on each razor handle. The user can then select from one of the razor cartridges based on the information provided. Such a method provides the user with an unlimited independent selection of both razor handles and razor cartridges.

### SUMMARY OF THE INVENTION

The present invention relates to a method of selecting from a system of shaving products. The method comprises providing information only on a first razor handle connectable in use with a razor blade cartridge with the first razor handle configured to provide a first operative effect. Information is provided only on a second razor handle connectable in use with the razor blade cartridge with the second razor handle configured to provide a second operative effect, different from the first operative effect. A selection of one of the first razor handle or the second razor handle is made.

The method may comprise the steps of providing information on the razor blade cartridge, with razor blade cartridge being connectable in use with each of the first razor handle and the second razor handle. A selection of the razor blade cartridge is made.

The step of providing information only on the first razor handle comprises providing at least one image of the first razor handle without an image of the razor blade cartridge.

The step of providing information only on the second razor handle comprises providing at least one image of the second razor handle without an image of the razor blade cartridge.

The step of providing information only on the first razor handle comprises providing a written text only on the first razor handle and no written text on the razor blade cartridge.

The step of providing information only on the second razor handle comprises providing a written text only on the second razor handle and no written text on the razor blade cartridge.

The method may comprise the steps of; providing information on a second razor blade cartridge with the second razor blade cartridge being different from the razor blade cartridge. The second razor blade cartridge is connectable in use with each of the first razor handle and the second razor handle. A selection of one of the razor blade cartridge or the second razor blade cartridge is made.

The first operative effect comprises physical movement, pivoting, rotating, no physical movement, cooling, heating, the delivery, dispensing or application of fluid and vibration.

The second operative effect comprises physical movement, pivoting, rotating, no physical movement, cooling, heating, the delivery, dispensing or application of fluid and vibration.

The first razor handle may be enclosed in a first single use disposable blister package, with the first single use disposable blister package enclosing only the first razor handle. The first single use disposable blister package may comprise a transparent surface.

The second razor handle may be enclosed in a second single use disposable blister package with the second single use disposable blister package enclosing only the second razor handle. The second single use disposable blister package may comprise a transparent surface. The first razor handle comprises a connection structure for connecting the razor handle with the razor blade cartridge and the second razor handle comprises a connection structure for connecting the razor handle with the razor blade cartridge.

The razor blade cartridge may be enclosed in a single use disposable razor blade cartridge package. The second razor blade cartridge may be enclosed in a second single use disposable razor blade cartridge package.

The method may comprise the steps of providing information only on a third razor handle connectable in use with the razor blade cartridge with the third razor handle configured to provide a third operative effect different from the first operative effect and the second operative effect. A selection of one of the first razor handle, the second razor handle or the third razor handle is made.

The step of providing information only on the third razor handle comprises providing at least one image of the third handle without an image of the razor blade cartridge.

The step of providing information only on the third razor handle comprises providing a written text only on the third razor handle and no written text on the razor blade cartridge.

The third operative effect comprises physical movement, pivoting, rotating, no physical movement, cooling, heating, the delivery, dispensing or application of fluid and vibration.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is an image of a shaving product.

FIG. 2 is an image of a shaving product.

FIG. 3 is an image of a razor blade cartridge.

FIG. 4 is an image of a shaving product.

FIG. 5 is an image of a shaving product.

FIG. 6 is an image of a razor blade cartridge.

FIG. 7 is an image of a razor blade cartridge.

FIG. 8 is a front plan view of a packaged shaving product.

FIG. 9 is a back plan view of the packaged shaving product of FIG. 8.

FIG. 10 is a cross-sectional view of the packaged shaving product of FIG. 1 taken along section line 10-10.

FIG. 11 is a front plan view of a single use disposable razor blade cartridge package.

FIG. 12 is an image of a shaving product.

FIG. 13 is an image of a shaving product.

FIG. 14 is an image of a shaving product.

FIG. 15 is an image of a shaving product.

### DETAILED DESCRIPTION OF THE INVENTION

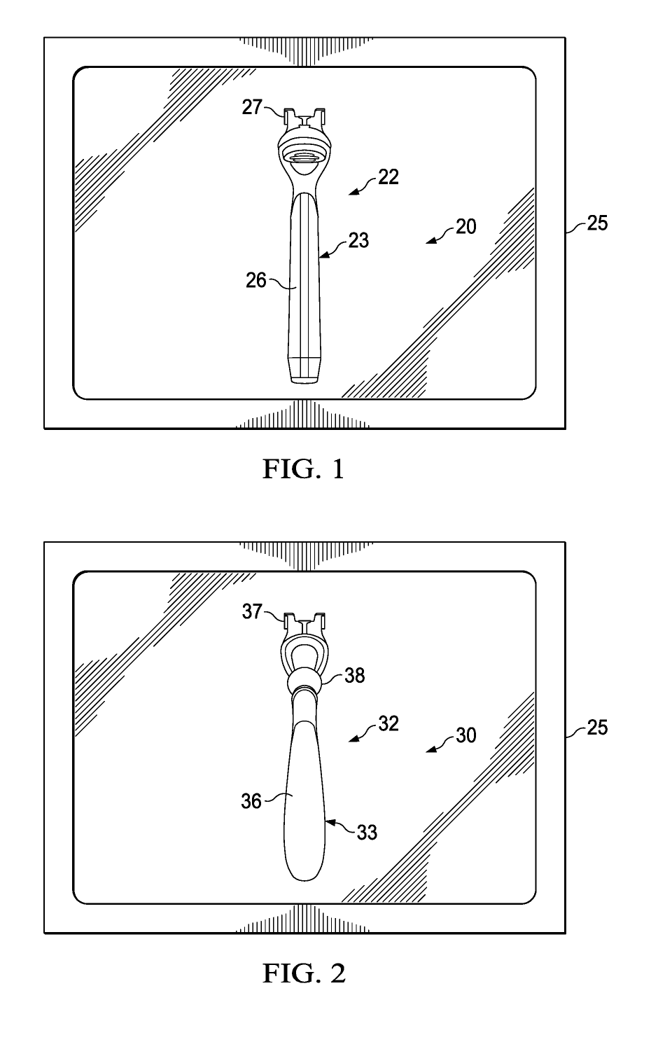

The present invention relates to a method of selecting from a system of shaving products. Referring to FIG. 1, there is shown an image 20 of a shaving product 22 of the present invention. The shaving product 22 comprises a first razor handle 23 connectable in use with a razor blade cartridge (not shown).

The image 20 is preferably displayed digitally such as on a mobile phone, television, or monitor such as a computer monitor and the like 25. The image 20 may also have been displayed in print form as well. The image 20 provides information only on the first razor handle 23 which is connectable in use with a razor blade cartridge. The image 20 does not provide any information on the razor blade cartridge or on any other razor handle which are not shown. The first razor handle 23 comprises a grip portion 26 allowing the user to grip the first razor handle 23 in use. The first razor handle comprises a connection structure 27 for connecting in use the first razor handle 23 with a razor cartridge.

The first razor handle 23 is configured to provide a first operative effect. The first operative effect may comprise physical movement such as pivoting and rotating. The first operative effect may comprise no physical movement such as no pivoting and no rotating. The first operative effect may be the application of cooling or heating. The first operative effect may be the delivery, dispensing, or application of fluid such as a shave preparation or lotion. The first razor handle 23 is configured to provide a first operative effect of no physical movement.

Referring to FIG. 2, there is shown an image 30 of a shaving product 32 of the present invention. The shaving product 32 comprises a second razor handle 33 connectable in use with a razor blade cartridge (not shown).

The image 30 is preferably displayed digitally such as on a mobile phone, television, or monitor such as a computer monitor and the like 25. The image 30 may also have been displayed in print form as well. The image 30 provides information only on the second razor handle 33 which is connectable in use with a razor blade cartridge. The image 30 does not provide any information on the razor blade cartridge or any other razor handle which are not shown. The second razor handle 33 comprises a grip portion 36 allowing the user to grip the second razor handle 33 in use. The second razor handle comprises a connection structure 37 for connecting in use the second razor handle 33 with a razor cartridge.

The second razor handle 33 is configured to provide a second operative effect. The second operative effect is different from the first operative effect. The second operative effect may comprise physical movement such as pivoting or rotating. The second operative effect may comprise no physical movement such as no pivoting and no rotating. The second operative effect may be the application of cooling or heating. The second operative effect may be the delivery, dispensing, or application of fluid such as a shave preparation or lotion. The second razor handle 33 is configured to provide a second operative effect of rotating via rotating portion 38.

The image 30 is preferably shown sequentially after image 20. Alternatively, or in addition, image 30 and image 20 may be shown at the same time. After providing information thru images 20 and 30 a user is able to select one of the first razor handle 23 or the second razor handle 33 based on the information provided. The information provided by the product images 20 and 30 allows the user to compare the features and differences between the two razor handles 23 and 33. The information allows the user to make a selection of either the first razor handle 23 or the second razor handle 33.

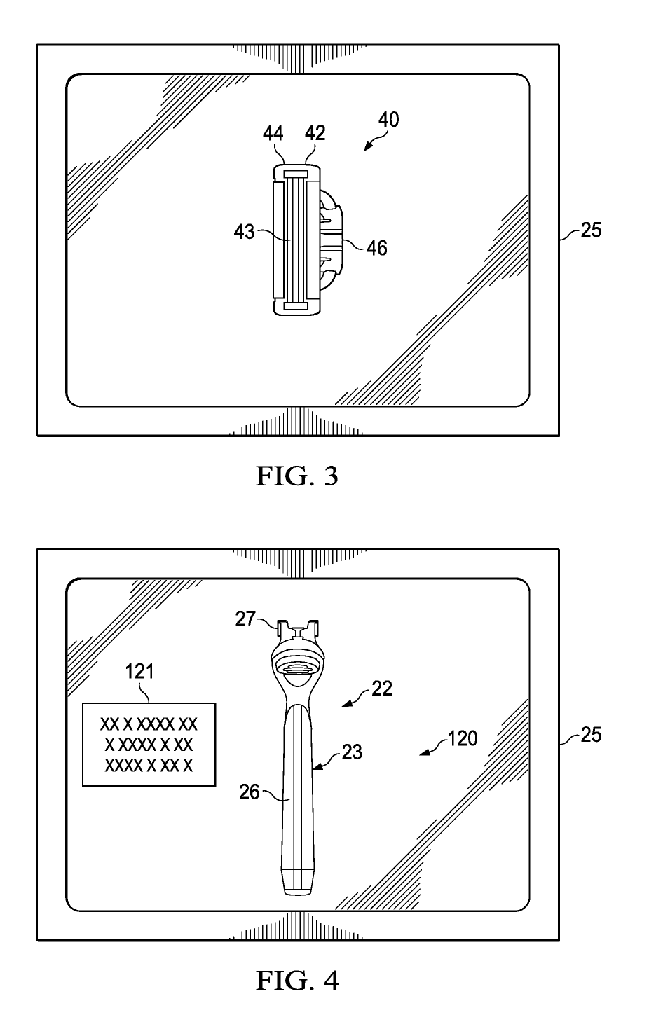

Referring now to FIGS. 1-3, the method may also include the further steps of providing information on the razor blade cartridge 42. In FIG. 3 there is shown an image 40 of a razor blade cartridge 42 of the present invention. The razor blade cartridge 42 is connectable in use with each of the first razor handle 23 and said second razor handle 33. The razor blade cartridge 42 comprises a housing 44 and a connection member 46 connectable in use with connecting structure 27 of first razor blade handle 23 and connecting structure 37 of second razor blade handle 33. The razor blade cartridge 42 comprises at least one blade 43. In the embodiment shown, razor blade cartridge 42 comprises three blades 43. After the image 40 is provided the user may select the razor blade cartridge 42.

The image 40 is preferably displayed digitally such as on a mobile phone, television, or monitor such as a computer monitor and the like 25. The image may also have been displayed in print form as well. The image 40 provides information only on the razor blade cartridge 42 which is connectable in use with first razor handle 23 and second razor handle 33. The image 40 does not provide any information on the first razor handle 23 or the second razor handle 33 which are not shown. The image 40 is preferably shown sequentially after images 20 and 30.

Referring now to FIG. 4, there is shown an image 120 of a shaving product 22 of the present invention. The shaving product 22 comprises a first razor handle 23 connectable in use with a razor blade cartridge (not shown). The shaving product 22 is the same shaving product 22 shown in FIG. 1.

The image 120 is preferably displayed digitally such as on a mobile phone, television, or monitor such as a computer monitor and the like 25. The image 120 may also have been displayed in print form as well. In addition to the image 120, written text 121 is also provided. The image 120 and written text 121 provide information only on the first razor handle 23 which is connectable in use with a razor blade cartridge. The image 120 and written text 121 do not provide any information on the razor blade cartridge or any other razor handles which are not shown. The first razor handle 23 comprises a grip portion 26 allowing the user to grip the first razor handle 23 in use. The first razor handle comprises a connection structure 27 for connecting in use the first razor handle 23 with a razor cartridge. The first razor handle 23 is configured to provide a first operative effect the same as the first operative effect of the razor shown in FIG. 1.

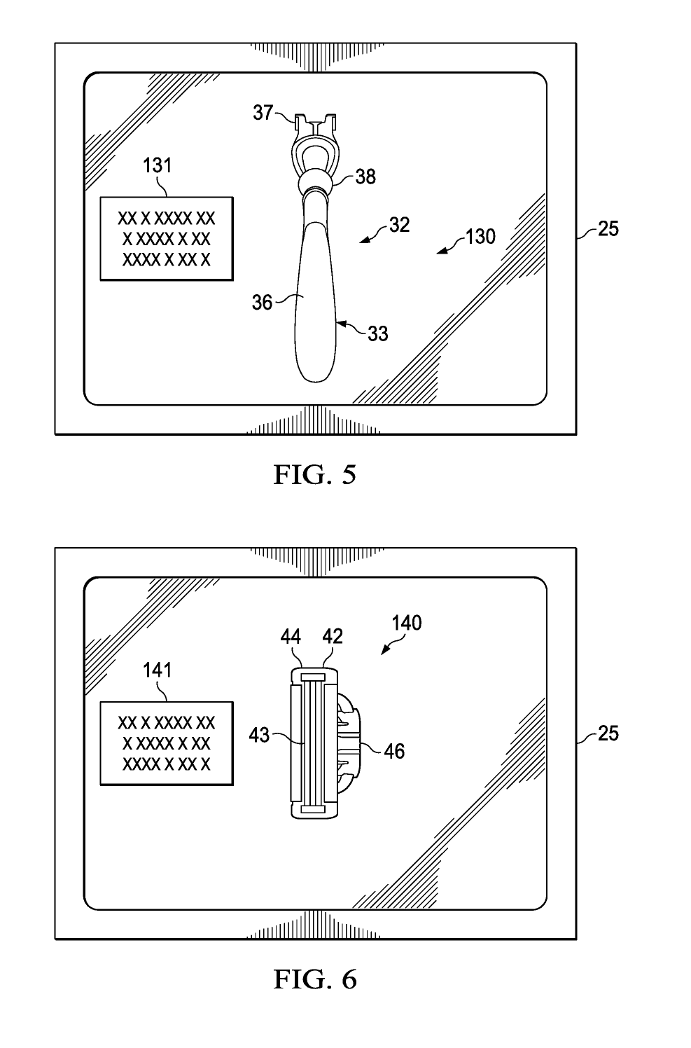

Referring now to FIG. 5, there is shown an image 130 of a shaving product 32 of the present invention. The shaving product 32 comprises a second razor handle 33 connectable in use with a razor blade cartridge (not shown). The shaving product 32 is the same shaving product 32 shown in FIG. 2.

The image 130 is preferably displayed digitally such as on a mobile phone, television, or monitor such as a computer monitor and the like 25. The image 130 may also have been displayed in print form as well. In addition to the image 130, written text 131 is also provided. The image 130 and written text 131 provide information only on the second razor handle 33 which is connectable in use with a razor blade cartridge. The second razor handle 33 is configured to provide a second operative effect. The second razor handle 33 is configured to provide a second operative effect of rotating via rotating portion 38. The image 130 and written text 131 do not provide any information on the razor blade cartridge or any other razor handles which are not shown. The second razor handle 33 comprises a grip portion 36 allowing the user to grip the second razor handle 33 in use. The second razor handle comprises a connection structure 37 for connecting in use the second razor handle 33 with a razor cartridge.

The image 130 and written text 131 is preferably shown sequentially after image 120 and written text 121. Alternatively, or in addition, image 130, written text 131, image 120 and written text 131 may be shown at the same time. After providing information thru image 120, written text 121, image 130 and written text 131 a user is able to select one of the first razor handle 23 or the second razor handle 33 based on the information provided. The information provided by the product images and written text allows the user to compare the features and differences between the two razor handles 23 and 33. The information allows the user to make a selection of either the first razor handle 23 or the second razor handle 33.

Referring now to FIGS. 1, 2 and 6, there is shown an image 140 of the razor blade cartridge 42. The razor blade cartridge 42 is the same as the razor blade cartridge 42 shown in FIG. 3. Razor blade cartridge 42 comprises a housing 44 and connection member 46 connectable in use with connecting structure 27 of first razor blade handle 23 and connecting structure 37 of second razor blade handle 33. The razor blade cartridge comprises at least one blade 43.

The image 140 is preferably displayed digitally such as on a mobile phone, television, or monitor such as a computer monitor and the like 25. The image 140 may also been displayed in print form as well. In addition to the image 140, written text 141 is also provided. The image 140 and written text 141 provide information only on the razor blade cartridge 42 which is connectable in use with a first razor handle 23 or second razor handle 33. The image 140 and written text 141 do not provide any information on the first razor handle 23 or second razor handle 33. After the image is provided the user may select the razor blade cartridge 42.

Referring now to FIGS. 1, 2 and 7, the method may comprise the steps of providing information on a second razor blade cartridge 52. The second razor blade cartridge 52 is connectable in use with each of the first razor handle 23 and the second razor handle 33. The information comprises an image 50 of the second razor blade cartridge 52. The second razor blade cartridge comprises a housing 52 and a connection member 56 connectable in use with connecting structure 27 of first razor blade handle 23 and connecting structure 37 of second razor blade handle 33. The second razor blade cartridge 52 is different from the razor blade cartridge 42. The second razor blade cartridge comprises five blades 53. The information may also include written text 51 on the second razor blade cartridge 52. After the information has been provided, the user then selects one of the razor blade cartridges 42 (shown in FIG. 6) having three blades or the second razor blade cartridge 52 having five blades.

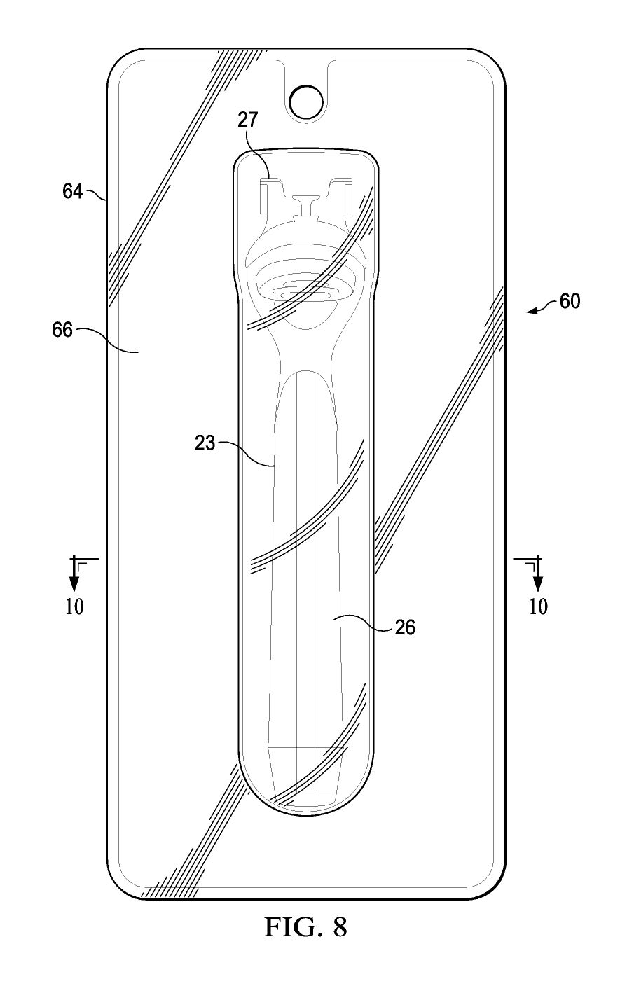

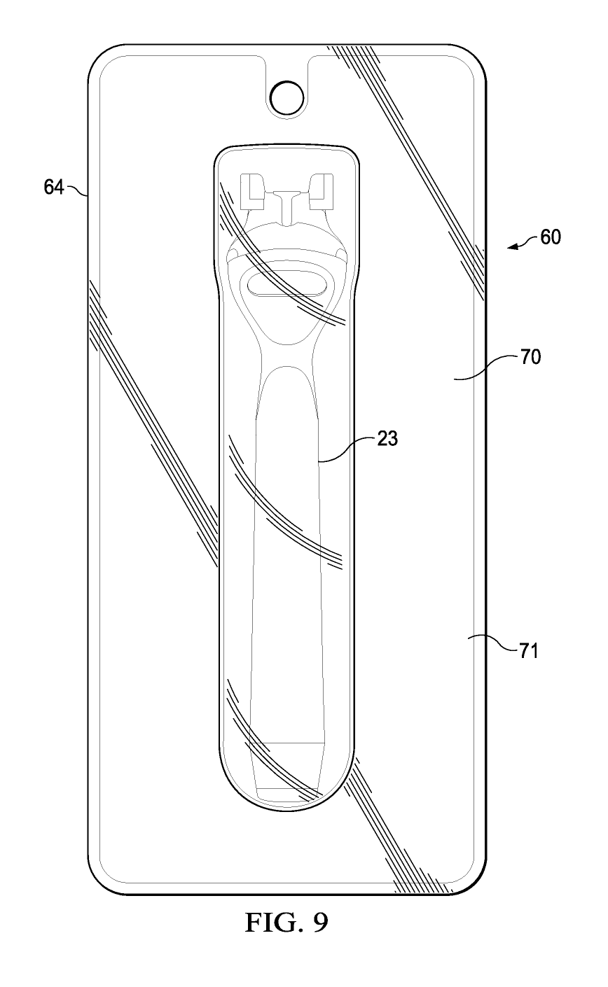

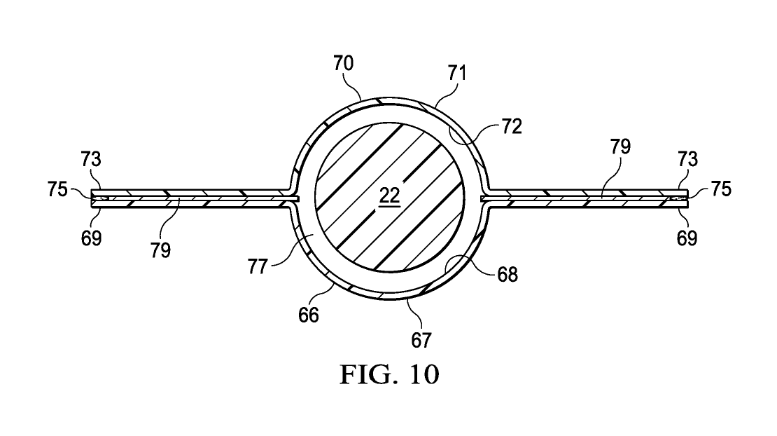

The shaving products may be enclosed in a package. Referring to FIGS. 8-10, there is shown a packaged shaving product 60 of the present invention. The packaged shaving product 60 comprises a first razor handle 23 connectable in use with a razor blade cartridge (not shown), and a single use disposable blister package 64 enclosing only the first razor handle 23. Instead of enclosing only the first razor handle, the packaged shaving product 60 may enclose only the second razor handle 33 or any other individual razor handle.

The single use disposable blister package 64 includes a front member 66 and a back member 70. Front member 66 has a first or outer surface 67, an opposing second or inner surface 68 and a front flange 69 extending around the periphery of front member 66.

Back member 70 has a first or outer surface 71, an opposing second or inner surface 72 and a back flange 73 extending around the periphery of back member 70.

A joint 75 secures the front flange 69 to the back flange 73. The joint 75 may be a heat seal, pressure seal, adhesive, or mechanical engagement securing the front flange 69 to the back flange 73. A cavity 77 is located between the front member 66 and the back member 70 and more particularly between the inner surface 68 of the front member 66 and the inner surface 72 of the back member 70. The razor handle 23 resides within the cavity 77. The razor handle 23 comprises a grip portion 26 and a connection structure 27 for connecting the razor handle 23 with a razor blade cartridge.

The front member 66 and the back member 70 may be formed from plastic. The front member 66 and back member 70 may be manufactured from generally translucent or transparent polymers such that consumers can view the razor handle within the single use disposable blister package 64. Opaque materials such as wood/paper pulp or Styrofoam may even be used if transparency is not required for either the front member 66 or back member 70 or both. Examples of transparent or translucent polymers may include, but are not limited to polyolefins (e.g., polypropylene, high density polyethylene or low-density polyethylene), polyesters (e.g., polyethylene terephthalate), and poly vinyl chloride (PVC). The front and back members may be produced by thermoforming or other known processing methods such as injection molding, blow molding, cold forming, and injection blow molding. The single use disposable blister package 64 also includes a card 79 between front member 66 and a back member 70. The single use disposable blister package 64 encloses only the first razor handle. That is, the single use disposable blister package 64 does not include any razor blade cartridges.

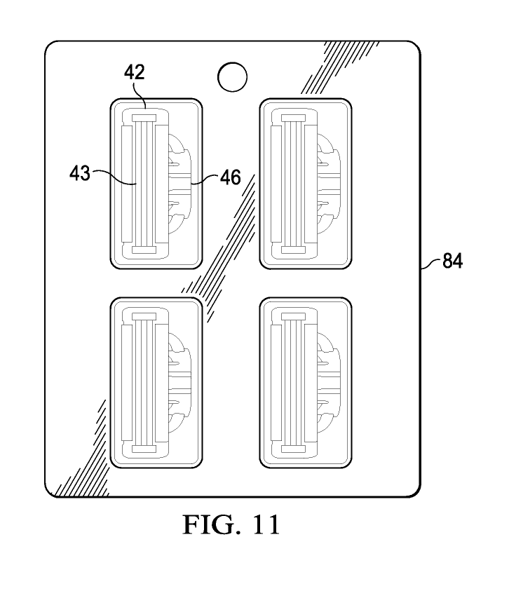

Referring now to FIGS. 1, 2 and 11, the razor blade cartridge 42 may be enclosed in a single use disposable razor blade cartridge package 84. The single use disposable razor blade cartridge package 84 encloses only razor blade cartridges 42. That is, the single use disposable razor blade cartridge package 84 does not include any razor blade handles. The single use disposable razor blade cartridge package 84 is shown with four razor blade cartridges 42. The single use disposable razor blade cartridge package 84 may contain other amounts of razor blade cartridges 42 such as 1, 2, 3, 6, 8, 10, etc. The razor blade cartridge 42 is connectable in use with each the first razor handle 23 and the second razor handle 33. The razor blade cartridges 42 comprise a handle connection structure 46 to connect in use razor blade cartridge 42 with each first cartridge connection structure 27 and second cartridge connection structure 37. The razor blade cartridges 42 each comprise at least one blade 43.

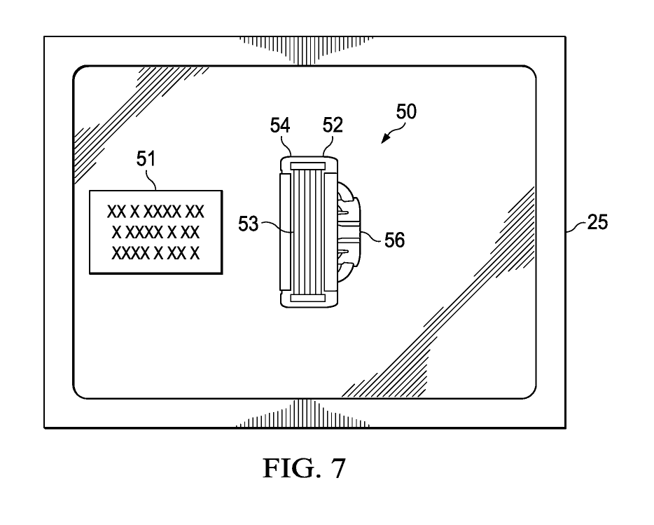

A similar single use disposable razor blade cartridge package may be used for second razor blade cartridge 52 shown in FIG. 7 and other razor blade cartridges.

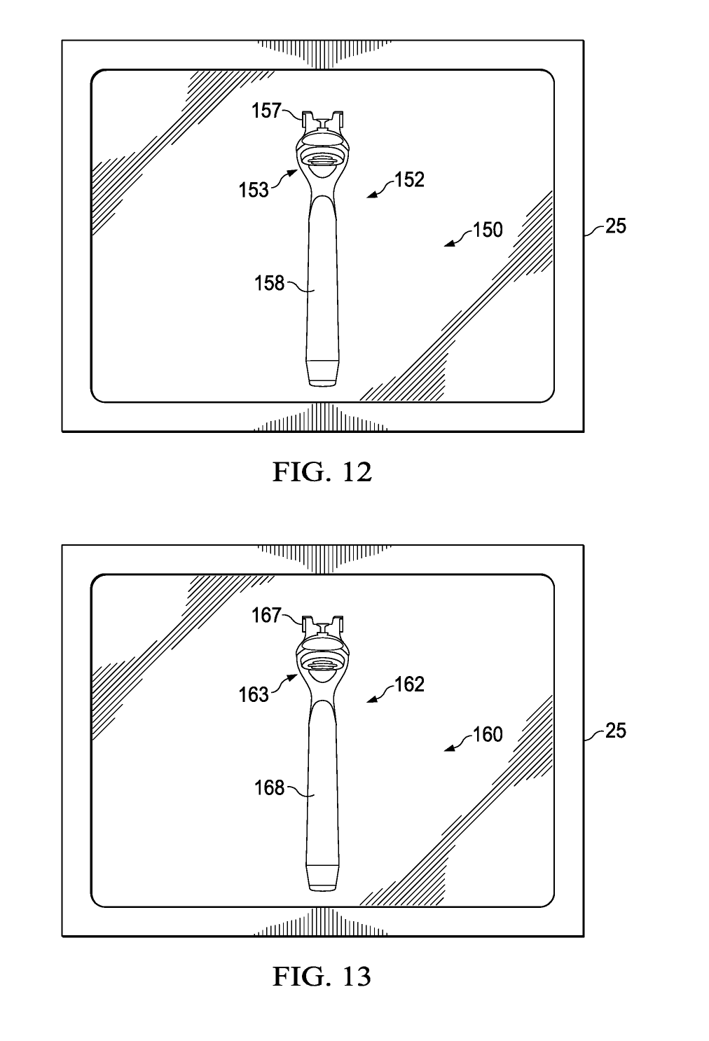

Referring now to FIG. 12 there is shown an image 150 of a third razor handle 152 connectable in use with a razor blade cartridge. Image 150 is preferably displayed digitally such as on a mobile phone, television, or monitor such as a computer monitor and the like 25. The third razor handle 152 comprises a cartridge connection structure 157 to connect in use third handle 152 with a razor blade cartridge. The third razor handle 152 comprises a grip portion 158 allowing the user to grip the third razor handle 152 in use. The third razor handle 152 is configured to provide a third operative effect. The third razor handle 152 is configured to provide a third operative effect of cooling via cooling portion 153. The third razor handle 152 may be enclosed in a single use disposable blister package like that shown in FIGS. 8-10.

Referring now to FIG. 13 there is shown an image 160 of a fourth razor handle 162 connectable in use with a razor blade cartridge. Image 160 is preferably displayed digitally such as on a mobile phone, television, or monitor such as a computer monitor and the like 25. The fourth razor handle 162 comprises a cartridge connection structure 167 to connect in use fourth handle 162 with a razor blade cartridge. The fourth razor handle 162 comprises a grip portion 168 allowing the user to grip the fourth razor handle 162 in use. The fourth razor handle 162 is configured to provide a fourth operative effect. The fourth razor handle 162 is configured to provide a fourth operative effect of heating via heating portion 163. The fourth razor handle 162 may be enclosed in a single use disposable blister package like that shown in FIGS. 8-10.

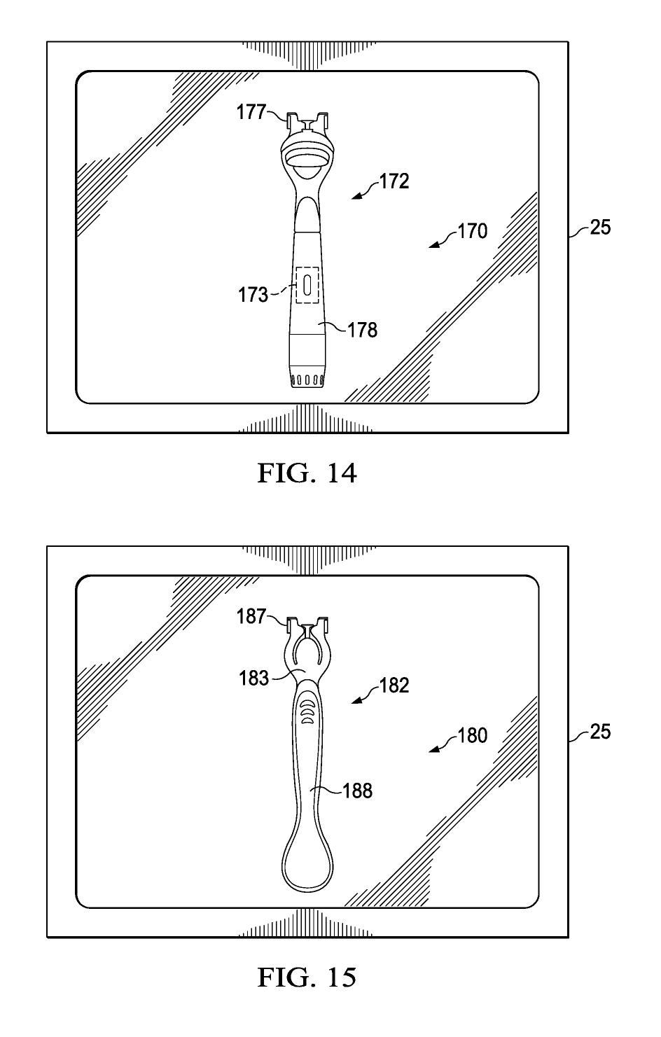

Referring now to FIG. 14 there is shown an image 170 of a fifth razor handle 172 connectable in use with a razor blade cartridge. Image 170 is preferably displayed digitally such as on a mobile phone, television, or monitor such as a computer monitor and the like 25. The fifth razor handle 172 comprises a cartridge connection structure 177 to connect in use fifth handle 172 with a razor blade cartridge. The fifth razor handle 172 comprises a grip portion 178 allowing the user to grip the fifth razor handle 172 in use. The fifth razor handle 172 is configured to provide a fifth operative effect. The fifth razor handle 172 is configured to provide a fifth operative effect of vibration via vibrating motor 173. The fifth razor handle 172 may be enclosed in a single use disposable blister package like that shown in FIGS. 8-10.

Referring now to FIG. 15 there is shown an image 180 of a sixth razor handle 182 connectable in use with a razor blade cartridge. Image 180 is preferably displayed digitally such as on a mobile phone, television, or monitor such as a computer monitor and the like 25. The sixth razor handle 182 comprises a cartridge connection structure 187 to connect in use sixth handle 182 with a razor blade cartridge. The sixth razor handle 182 comprises a grip portion 188 allowing the user to grip the sixth razor handle 182 in use. The sixth razor handle 182 is configured to provide a sixth operative effect. The sixth razor handle 182 is configured to provide a sixth operative effect of fluid delivery, application or dispensing via fluid delivery portion 183. The sixth razor handle 182 may be enclosed in a single use disposable blister package like that shown in FIGS. 8-10.

Referring now to FIGS. 1-15, razor blade cartridges 42 and 52 are connectable in use with each the first razor handle 23, the second razor handle 33, the third razor handle 152, the fourth razor handle 162, the fifth razor handle 172 and the sixth razor handle 182. The razor blade cartridges 42 and 52 each comprise handle connection structures 46 and 56 to connect in use razor blade cartridges 42 and 52 with each first cartridge connection structure 37, second cartridge connection structure 37, third cartridge connection structure 157, fourth cartridge connection structure 167, fifth cartridge connection structure 177, and sixth cartridge connection structure 187.

The info provided on the first razor handle thru the sixth razor handle allows the user to select one of the handles best suited for their use. After the user selects a handle from one of the first razor handle thru the sixth razor handle, the user can then select one of the first or second razor blade cartridges.

The present invention relates to a method of selecting from a system of shaving products. The system of shaving products comprises information on first razor handle 23 connectable in use with a razor blade cartridge. The first razor handle 23 is configured to provide a first operative effect. The system of shaving products comprises information on second razor handle 33 connectable in use with a razor blade cartridge. The second razor handle 33 is configured to provide a second operative effect, different from said first operative effect. The system of shaving products comprises information on razor blade cartridge 42. The razor blade cartridge 42 is connectable in use with each of the first razor handle 23 and the second razor handle 33. The method comprises selecting one of the first or the second razor handle, 23 or 33, and selecting the razor blade cartridge package 42.

The present invention relates to a method of selecting from a system of shaving products. The system of shaving products comprises information on first razor handle 23 connectable in use with a razor blade cartridge. The first razor handle 23 configured to provide a first operative effect. The system of shaving products comprises information on second razor handle 33 connectable in use with a razor blade cartridge. The second razor handle 33 is configured to provide a second operative effect, different from said first operative effect. The system of shaving products comprises information on first razor blade cartridge 42. The first razor blade cartridge 42 is connectable in use with each of the first razor handle 23 and the second razor handle 33. The system of shaving products comprises info on second razor blade cartridge 52. The second razor blade cartridge 52 is connectable in use with each of the first razor handle 23 and the second razor handle 33.

The method comprises selecting one of the first or the second razor handles, 23 or 33, and selecting one of the razor blade cartridges 42 or 52.

The system of shaving products may comprise info on a third razor handle 152 connectable in use with a razor blade cartridge. The third razor handle 152 is configured to provide a third operative effect.

The method comprises selecting one of the first, second or third razor handles and selecting one of the blade cartridges 42 or the razor blade cartridges 52. The method may comprise information on additional razor handles and cartridges. The information may be in the form of images and written text or both.

### COMBINATIONS

A. A method of selecting from a system of shaving products, the method comprising:

providing information only on a first razor handle connectable in use with a razor blade cartridge, said first razor handle configured to provide a first operative effect;

providing information only on a second razor handle connectable in use with the razor blade cartridge, said second razor handle configured to provide a second operative effect, different from said first operative effect; and

selecting one of the first razor handle or the second razor handle.

B. The method of Paragraph A, further comprising the steps of;

providing information on the razor blade cartridge, said razor blade cartridge being connectable in use with each of said first razor handle and said second razor handle; and

selecting the razor blade cartridge.

C. The method of Paragraphs A or B, wherein the step of providing information only on the first razor handle comprises providing at least one image of the first razor handle without an image of the razor blade cartridge.
D. The method of Paragraphs A through C, wherein the step of providing information only on the second razor handle comprises providing at least one image of the second razor handle without an image of the razor blade cartridge.
E. The method of Paragraphs A through D, wherein the step of providing information only on the first razor handle comprises providing a written text only on the first razor handle and no written text on the razor blade cartridge.
F. The method of Paragraphs A through E, wherein the step of providing information only on the second razor handle comprises providing a written text only on the second razor handle and no written text on the razor blade cartridge.
G. The method of Paragraphs A through F, further comprising the steps of;

providing information on a second razor blade cartridge, said second razor blade cartridge being different from said razor blade cartridge, said second razor blade cartridge being connectable in use with each of said first razor handle and said second razor handle; and

selecting one of the razor blade cartridge or the second razor blade cartridge.

H. The method of Paragraphs A through G, wherein the first operative effect comprises physical movement, pivoting, rotating, no physical movement, cooling, heating, the delivery, dispensing or application of fluid and vibration.
I. The method of Paragraphs A through H, wherein the second operative effect comprises physical movement, pivoting, rotating, no physical movement, cooling, heating, the delivery, dispensing or application of fluid and vibration.
J. The method of Paragraphs A through I, wherein the first razor handle is enclosed in a first single use disposable blister package, said first single use disposable blister package enclosing only said first razor handle.
K. The method of Paragraph J, wherein the first single use disposable blister package comprises a transparent surface.
L. The method of Paragraphs A through K, wherein the second razor handle is enclosed in a second single use disposable blister package, said second single use disposable blister package enclosing only said second razor handle.
M. The method of Paragraph L, wherein the second single use disposable blister package comprises a transparent surface.
N. The method of Paragraphs A through M, wherein the first razor handle comprises a connection structure for connecting the razor handle with the razor blade cartridge and the second razor handle comprises a connection structure for connecting the razor handle with the razor blade cartridge.
O. The method of Paragraphs A through N, wherein the razor blade cartridge is enclosed in a single use disposable razor blade cartridge package.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system of shaving products, the system comprising:
a first razor handle, the first razor handle being enclosed in a first single use disposable blister package, the first single use disposable blister package enclosing only the first razor handle; the first razor handle is configured to provide a first operative effect, the first razor handle being connectable in use with a razor blade cartridge;
a second razor handle, the second razor handle being enclosed in a second single use disposable blister package, the second single use disposable blister package enclosing only the second razor handle; the second razor handle is configured to provide a second operative effect different than the first operative effect, the second razor handle being connectable in use with the razor blade cartridge.

2. The system of claim 1, further comprising a second razor blade cartridge, said second razor blade cartridge being different from said razor blade cartridge, said second razor blade cartridge being connectable in use with each of said first razor handle and said second razor handle.

3. The system of claim 1, wherein the first operative effect comprises physical movement, pivoting, rotating, no physical movement, cooling, heating, the delivery, dispensing or application of fluid and vibration.

4. The system of claim 1, wherein the second operative effect comprises physical movement, pivoting, rotating, no physical movement, cooling, heating, the delivery, dispensing or application of fluid and vibration.

5. The system of claim 1, wherein the first single use disposable blister package comprises a transparent surface.

6. The system of claim 1, wherein the second single use disposable blister package comprises a transparent surface.

7. The system of claim 1, wherein the first razor handle comprises a connection structure for connecting the razor handle with the razor blade cartridge and the second razor handle comprises a connection structure for connecting the razor handle with the razor blade cartridge.

8. The system of claim 1, wherein the razor blade cartridge is enclosed in a single use disposable razor blade cartridge package.

9. The system of claim 2, wherein the second razor blade cartridge is enclosed in a second single use disposable razor blade cartridge package.

10. The system of claim 1, further comprising a third razor handle connectable in use with the razor blade cartridge, the third razor handle configured to provide a third operative effect, different from the first operative effect and the second operative effect.

11. The system of claim 10, wherein the third operative effect comprises physical movement, pivoting, rotating, no physical movement, cooling, heating, the delivery, dispensing or application of fluid and vibration.
